(19) United States
(12) Patent Application Publication
(10) Pub. No.: US 2004/0051813 A1
(43) Pub. Date: Mar. 18, 2004

(54) Television power saving system

(75) Inventor: George Marmaropoulos, York Town Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTRONICS N.V.

(21) Appl. No.: 10/245,432

(22) Filed: Sep. 17, 2002

(51) Int. Cl. H04N 5/44

(52) U.S. Cl. 348/553; 348/730

(57) ABSTRACT

A television receiver, or some other display device, includes a display, a video signal processing circuit, a display driving circuit, and a control unit for controlling the video signal processing circuit and the display driving circuit. In order to reduce power consumption by the television receiver when the television receiver is not being viewed, the television receiver includes a presence detector for detecting the presence of a person in a room containing the television receiver. When the presence detector does not detect the presence of a person, the control unit disables the display by turning off either the video signal processing circuit or the display driving circuit, or both. When the person re-enters the room, the presence detector indicate this to the controller which then re-enables the display by turning on the video signal processing circuit and/or the display driving circuit. In order to prevent inadvertently disabling the display, the control unit waits until the presence detector does not detect the presence of a person in the room for a predetermined period of time.

### BACKGROUND OF THE INVENTION

1. Field of the Invention

The subject invention relates to television receivers and, more particularly, an apparatus for reducing the amount of power consumed by a television receiver.

2. Description Of The Related Art

In a typical household, it is very common for a television receiver to be left on in one room while the occupant of the household is busy doing something else in another room. While the occupant could turn off the television receiver, the occupant usually leaves the television receiver on so that the occupant may keep up with a desired program by listening to the audio sound track, or listening for the start of a particularly desirable portion of the program being broadcast, for example, the beginning of the sports report on the news.

There are various circuits in a television receiver which consume power including the tuner, the audio signal processing circuits, and the video signal processing circuits. Of these circuits, the video display portion of the video signal processing circuit consumes a significant amount of power, particularly in the case of a cathode ray tube, in which considerable power is required to heat the grids of the electron guns to the appropriate temperature, and to generate the electron beams which are scanned across the front surface of the cathode ray tube to form the displayed image.

### SUMMARY OF THE INVENTION

It is an object of the present invention to provide a display device in which the consumption of power is reduced by turning off the display when a viewer is not in the room with the display device.

This object is achieved in a display device comprising a display; a video signal processing circuit for generating a display signal, said display signal being applied to an input of said display; a display driving circuit for generating control signals for controlling said display; and a control unit for controlling said video signal processing circuit and said display driving circuit, wherein said display device further comprises: means for detecting the presence of a person in a room containing the display device; and means for disabling at least one of the video signal processing circuit and said display driving circuit when said detecting means does not detect the presence of a person in the room.

With such a display device, when a person operating the display device leaves the room containing the display device, the display device inactivates the display until someone re-enters the room. As such, the power which would have been consumed by the display is saved.

In a preferred embodiment of the display device, the disabling means waits until said detecting means does not detect the presence of a person for a predetermined period of time before disabling at least one of the video signal processing circuit and said display driving circuit. Arranged as such, this prevents the display from being inactivated inadvertently when, for example, the person using the display device briefly leaves the room.

The presence detecting means may be in the form of a motion detector, an infrared heat detector, or a combination of a motion detector and an infrared heat detector. Alternatively, any other type of sensor may be used to detect a person's presence in a room. For example, the presence detector could be a sensor on the carpet, furniture, etc., or a radio frequency identification (RFID) tag-type of detection, etc. In fact, these types of sensors for detecting presence and the identification of home occupants, may indeed be in use in a future home environment.

A particularly preferred embodiment of the subject invention is where the display device is incorporated in a television receiver.

### BRIEF DESCRIPTION OF THE DRAWINGS

With the above and additional objects and advantages in mind as will hereinafter occur, the subject invention will be described with reference to the accompanying drawings, in which:

FIG. 1 shows a plan view of a room containing a television receiver in accordance with the invention; and

FIG. 2 shows a block schematic diagram of a television receiver incorporating the invention.

### DESCRIPTION OF THE PREFERRED EMBODIMENTS

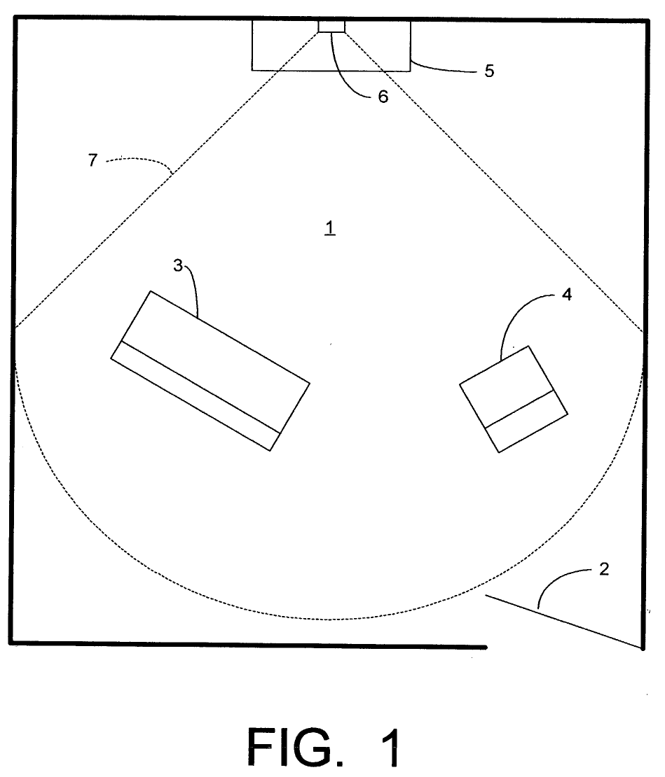

FIG. 1 shows a plan view of a room 1 having a door 2. The room 1 contains, for example, a sofa 3 and a chair 4. In addition, a television receiver 5 is positioned against the wall opposite the door 2. The television receiver 5 includes a presence detector 6 mounted in (or on) the television receiver 5 for detecting the presence of one or more persons in the room 1. The presence detector 6 generally detects the presence of people within the area enclosed by the dotted line 7. When a person is in the room seated in, for example, either the sofa 3 or the chair 4, the television receiver 5 operates normally, i.e., when turned on, a picture appears on the screen and the appropriate sounds are emitted by the contained loudspeaker. However, when the person exits the room, e.g., via the door 2 without turning off the television receiver 5, the presence detector 6 detects his/her absence. After a predetermined time, if the person (or someone else) has not re-entered the room, the presence detector 6 causes the television receiver 5 to switch off the video portion while only the audio portion of the television receiver 5 remains active.

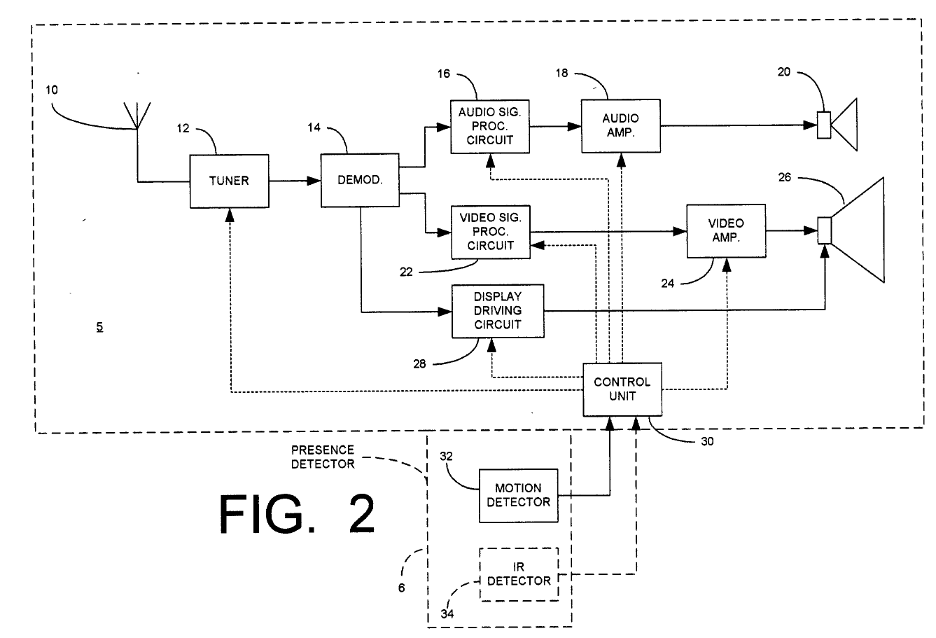

FIG. 2 shows a schematic block diagram of the television receiver 5 and the detector 6. The television receiver includes an antenna 10 for receiving broadcast television signals. While an antenna is shown, it should be understood that the antenna may be replaced by a cable connection for a cable television system, a satellite television receiver, or a connection to some other video source, e.g., a video cassette recorder/player, a DVD player, etc. The antenna 10 is connected to a tuner 12 for tuning to a specific one of the broadcast television signals. An output of the tuner 12 is connected to a demodulator 14 for separating the television signal into audio signals, video signals, and synchronization signals.

The audio signals are applied to an audio signal processing circuit 16 which processing the audio signals into sound signals. These sound signals are amplified in audio amplifier 18 and then applied to a loudspeaker 20.

The video signals are applied to a video signal processing circuit 22 which processes the video signals into display signals. After being amplified in video amplifier 24, the display signals are applied to a display 26 for generating visible images.

Finally, the synchronization signals are applied to a display driving circuit 28, which may be a deflection circuit for a cathode ray tube. The display driving circuit 28 generates control signals (e.g., deflection signals) for controlling the display 26 in generating the visible images.

A control unit 30 is included for controlling the tuner 12 to select a desired one of the broadcast television signals, the audio signal processing circuit 16 and the audio amplifier 18 for adjusting the tonal quality and loudness of the sound signal reproduced by the loudspeaker 20, the video signal processing circuit 22 and the video amplifier 24 for adjusting the video quality of the display signal to be displayed by the display 26, and the display driving circuit 28.

As shown in FIG. 2, the presence detector 6 includes a motion detector 32 connected to the control unit 20. Ordinarily, a person in the room watching the television receiver generally moves to a certain extent, e.g., lifting a glass to drink, nodding, gesturing with his/her hands, etc. When the motion detector 32 does not detect any motion indicating that the person has left the room, the motion detector 32 indicates the same to the control unit 30 which then turns off the display 26 using control signals to the display driving circuit 28 and the video signal processing circuit 22 and video amplifier 24. After that, when the motion detector 32 detects motion in the room indicating that the person has returned, it indicates this to the control unit 30 which re-activates the display 26 using the control signals to the video signal processing circuit 22, the video amplifier 24 and the display driving circuit 28. In order to prevent inadvertently turning off the display 26 the person has only briefly left the room, the control unit 30 may delay turning off the display 26 until the motion detector 32 detects no motion for more than a predetermined period of time.

As shown in FIG. 6, the presence detector 6 may also include an infrared heat (IR) detector 34 for additionally detecting the presence of a person in the room. As is known, a living person generates heat. This can be detected by the IR detector 34. When a person leaves the room, the absence of this generated heat may then be detected by the IR detector 34 in addition to the lack of motion in the room being detected by the motion detector 32.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

What is claimed is:

1. A display device comprising:
a display;
a video signal processing circuit for generating a image signal, said image signal being applied to an input of said display;
a display driving circuit for generating control signals for controlling said display; and
a control unit for controlling said video signal processing circuit and said display driving circuit, wherein said display device further comprises:
means for detecting the presence of a person in a room containing the display device; and
means for disabling at least one of the video signal processing circuit and said display driving circuit when said detecting means does not detect the presence of a person in the room.

2. The display device as claimed in claim 1, wherein said disabling means waits until said detecting means does not detect the presence of a person for a predetermined period of time before disabling at least one of the video signal processing circuit and said display driving circuit.

3. The display device as claimed in claim 1, wherein said detecting means comprises a motion detector.

4. The display device as claimed in claim 1, wherein said detecting means comprises an infrared heat detector.

5. The display device as claimed in claim 3, wherein said detecting means further comprises an infrared heat detector.

6. A television receiver comprising:
input means for receiving a television signal;
a demodulator for demodulating the television signal and for providing an audio signal, a video signal, and synchronizing signals;
an audio signal processing circuit for processing said audio signal and for generating a corresponding sound signal;
loudspeaker means coupled to said audio signal processing circuit for generating sounds corresponding to said sound signal;
a video signal processing circuit for processing said video signal and for generating corresponding display signals;
a display device having an input for receiving said display signals, said display device forming images corresponding to said display signals;
a display driving circuit having an input for processing said synchronizing signals and for generating control signals for said display device; and
a control unit for controlling said audio signal processing circuit, said video signal processing circuit, and said display driving circuit, wherein said television receiver further comprises:
means for detecting the presence of a person in a room containing the television receiver; and
means for disabling at least one of the video signal processing circuit and said display driving circuit when said detecting means does not detect the presence of a person in the room.

7. The television receiver as claimed in claim 6, wherein said disabling means waits until said detecting means does not detect the presence of a person for a predetermined period of time before disabling at least one of the video signal processing circuit and said display driving circuit.

8. The television receiver as claimed in claim 6, wherein said detecting means comprises a motion detector.

9. The television receiver as claimed in claim 6, wherein said detecting means comprises an infrared heat detector.

10. The television receiver as claimed in claim 8, wherein said detecting means further comprises an infrared heat detector.
